(19) United States
(12) Patent Application Publication
(10) Pub. No.: US 2015/0106313 A1
(43) Pub. Date: Apr. 16, 2015

(54) PREDICTIVE MODELING OF HIGH-BYPASS TURBOFAN ENGINE DETERIORATION

(71) Applicant: General Electric Company, Schenectady, NY (US)

(72) Inventors: Neil Holger White Eklund, Oakland, CA (US); Mohak Shah, Dublin, CA (US); Daniel Edward Marthaler, Oakland, CA (US); Christina Marie Brasco, New Haven, CT (US)

(21) Appl. No.: 14/512,159

(22) Filed: Oct. 10, 2014

Related U.S. Application Data
(60) Provisional application No. 61/890,134, filed on Oct. 11, 2013.

(51) Int. Cl. G06N 3/08

(52) U.S. Cl. CPC G06N 3/08
USPC 706/21

(57) ABSTRACT

A method, medium, and system to receive actual operational flight data for an engine of a particular type and configuration; train a neural network to generate an indicator of the health of the engine based on multiple different inputs to the neural network at a time the flight data was acquired; determine a deterioration factor for the engine, based at least in part, on an operational climate for the engine; and provide a record of the determined deterioration factor.

### BACKGROUND

The present disclosure relates to turbofan engine deterioration and using predictive modeling and optimization.

As profit-motivated organizations, manufacturers and users of high-bypass turbofan engines strive to use and take care of their engines in the most cost and time-efficient way possible. Accordingly, the deterioration of high-bypass turbofan aircraft engines is an area of study that has the potential to provide valuable information to both engine manufacturers and users. The differences in deterioration between engines corresponding to different airlines, climates or flight patterns offer insight into ideal maintenance patterns and fine-tuned estimates on engine lifetime for airlines that operate over a wide range of conditions. However, with the variation in flight patterns, and environmental conditions across airlines, continents and even aircraft, it is clear that a one-size-fits-all maintenance program will not be the best solution for all airlines using the same type of engine.

Many studies of turbine engine deterioration have been performed in recent years. Some, such as the damage propagation modeling study by Saxena, Goebel, Simon and Eklund (2008), use simulated models of turbine engines to predict how they will react to different conditions. In some aspects, these studies are immensely helpful in determining the general character of engine deterioration. Other studies consider the effectiveness of different strategies for the detection of deterioration patterns or faults (e.g., Krok & Ashby, 2002; Changzheng & Yong, 2006; and Weizhong & Feng, 2008).

The deterioration of high-bypass turbofan aircraft engines is an area of study that has the potential to provide valuable information to many parties a, including for example both engine manufacturers and users. Differences in deterioration between engines corresponding to different airlines, climates and/or flight patterns offer insight into ideal maintenance patterns and fine-tuned estimates on engine lifetime for airlines that operate over a wide range of conditions.

It would therefore be desirable to provide information that allows for tailoring maintenance programs to fit the usage profile(s) of a given airline to address the above-stated issues.

### DRAWINGS

These and other features, aspects, and advantages of the present disclosure will become better understood when the following detailed description is read with reference to the accompanying drawings in which like characters represent like parts throughout the drawings, wherein:

FIG. 1 depicts a histogram of ambient temperature (degrees C.°) of primed data set in accordance with one or more embodiments shown or described herein;

FIG. 2 depicts in graph form residual EGT vs. Time (days, in MATLAB format) for a single engine in accordance with one or more embodiments shown or described herein;

FIG. 3 depicts in graph form a jump found (marked with vertical lines) using identification criteria on graphs with slightly different shapes in accordance with one or more embodiments shown or described herein;

FIG. 4 depicts in graph form a jump found (marked with vertical lines) using identification criteria on graphs with slightly different shapes in accordance with one or more embodiments shown or described herein;

FIG. 5 depicts in graph form a jump found (marked with vertical lines) using identification criteria on graphs with slightly different shapes in accordance with one or more embodiments shown or described herein;

FIG. 6 depicts in graph form residual EGT (degrees C.) vs. time (days, in MATLAB format) for a single engine before clustering in accordance with one or more embodiments shown or described herein;

FIG. 7 depicts in graph form residual EGT (degrees C.) vs. time (days, in MATLAB format) for a single engine after clustering in accordance with one or more embodiments shown or described herein;

FIG. 8 depicts in graph form a distribution of deterioration coefficients for a single airline in accordance with one or more embodiments shown or described herein;

FIG. 9 depicts in graph form distribution of deterioration coefficients for an alternate single airline in accordance with one or more embodiments shown or described herein;

FIG. 10 depicts in graph form distribution of deterioration coefficients for an alternate single airline in accordance with one or more embodiments shown or described herein;

FIG. 11 depicts in graph form functions of deterioration coefficients with points for different airlines operating in Equatorial in accordance with one or more embodiments shown or described herein;

FIG. 12 depicts in graph form functions of deterioration coefficients with points for different airlines operating in Arid in accordance with one or more embodiments shown or described herein;

FIG. 13 depicts a flow diagram of a predictive modeling process, in accordance with one or more embodiments shown or described herein;

FIG. 14 depicts a logical depiction of a system, according to some embodiments; and

FIG. 15 depicts a device, according to some embodiments herein.

### DETAILED DESCRIPTION

Some aspects of the present disclosure take into consideration the effects of maintenance events on a deterioration pattern. However, instead of incorporating maintenance events as process noise, identification of these events and their locations have been used as starting and stopping points in analysis. An analysis performed herein differs from these past studies in a number of ways. For example, in using real snapshot data from engines belonging to several different airlines (e.g., contexts), consideration has been given to an average effect of certain environmental conditions on a group of engines.

Disclosed herein is a model of high-bypass turbofan aircraft engine deterioration based on cycle frequency, air quality, relative passenger mass and climate and its possible application as a predictor of engine health and lifetime. Solving this problem requires several steps of analysis. First, a neural network is trained using five inputs bleed ratio, altitude, Mach number, ambient temperature and N1 indicated (% RPM) and one output, exhaust gas temperature (EGT). Based on a three-year range of the data set and the assumption that engine health declines with time, it was inferred that the data set of interest for constructing a deterioration model would be the residual EGTs (compared with the neural networks prediction) vs. time for several different engines. These data set points were clustered and smoothed to obtain a linear regression could be performed between maintenance events, providing an indicator of how quickly the engine decayed over a three-year period. After following these disclosed steps for one configuration of a high-bypass turbofan engines, deterioration statistics were grouped by air-line and climate by Applicants. Within climate groups, the dependency of the deterioration coefficient on air quality, flight frequency and passenger configuration was examined Applicants derived a model that can be used to predict how long a high-bypass turbofan engine will last under given conditions, allowing for example, manufacturers to give better recommendations and predictions to users of the jet engines.

In some aspects, due to the quantity of interest being long-term changes in engine health, the data set of some embodiments herein was midflight snapshot data, grouped as a set of time-series corresponding to different engines. Ultimately, a model was derived that can be used to predict how long a high-bypass turbofan engine will last under given conditions. It is noted that in some embodiments, all of the engines used in examples of the present disclosure were the same configuration and model. Accordingly, the numeric results are most valid when predicting health of engines of the same variety. It is anticipated that the approaches disclosed herein may be used for any type of engine given sufficient, available data. The results may allow manufacturers and others to provide better maintenance recommendations to owners of the assets.

In some embodiments, experimental strategy was used to create a model of deterioration for one type of engine. The selected strategy was based on the use of a trained neural network to predict Exhaust Gas Temperature (EGT), an indicator of engine health, and the analysis of changes in EGT over time for several different engines. Disclosed herein is the general trend that was observed by Applicants in the data as a means of characterizing the deterioration of high-bypass turbofan engines and the observed relationships between the following flight conditions: cycle frequency, environment, passenger load and air quality. Two different sets of airlines, grouped by climate, were used as case studies. In addition, disclosed are the main results and several possible uses of this information for engine manufacturers, airlines, and others.

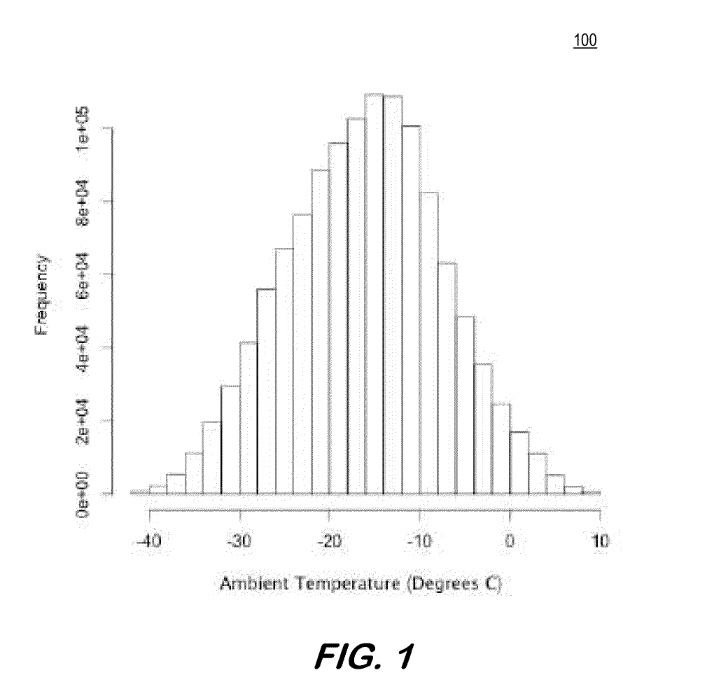

Referring more specifically to FIG. 1, illustrated in graph format is a histogram 100 of ambient temperature (degrees C.°) of primed data set in accordance with one or more embodiments shown or described herein. More particularly, illustrated is the distribution of ambient temperatures from a primed data set. For the purposes of this disclosure, the data set of interest was snapshot flight data from one type and configuration of high-bypass turbofan engines recorded over three years. Before training or testing the neural network, the data was preprocessed in two different steps. First, data points with one or more missing values were removed from the set. Next, the distribution of each variable was considered separately and, as each resembled a normal distribution; the tails of these distributions (mostly extreme outliers) were discarded to reduce the variance of the entire data set.

In this analysis, a trained neural network was used to predict EGT given five different inputs at the time that the snapshot was recorded. The five different inputs can include Bleed Ratio, Mach number (ratio of airplane speed to the speed of sound through air), ambient temperature, N1 (the percentage of maximum fan speed of the engine, directly related to throttle setting) and altitude. An artificial neural network used herein is modeled after a biological neural network: with several hidden elements (called nodes) and weights assigned to the connections between input, hidden and output nodes. Each hidden and output node has an activation function associated with it, through which an appropriately weighted sum is passed to determine the output of the node. Because of the complex interior structure of a neural network, it has the ability to be trained to accurately predict an output given a series of inputs for arbitrarily complex functions (Jain, Mao and Mohiuddin, 1996). This quality makes a neural network an ideal choice for approximating unknown function of EGT based on several inputs.

The training of the neural network takes place in two steps. The first step, feed-forward, involves sending the inputs for a given data point through the activation functions at the various levels. Then, in back-propagation, the different sets of weights are adjusted based on the derivative of the activation function, values of the weights and error in the output for the given data point (Jain et al., 1996). The neural network used herein contains one hidden layer with five nodes. There was a sigmoid activation function from the input layer to the hidden layer and from the hidden to the output layer with adjustable weights at each step.

The training data for the neural network herein was created by averaging subsets of points in the snapshot flight data. This was done to create a training data set that was completely separate from the testing set and to reduce the variance in the training data set. To do so, limits of between five and fourteen bins were set for each input variable such that each bin contained a non-negligible number of points. Then, the entire data set was divided into 5-dimensional hypercubes bounded on each side by a bin from one input parameter. All of the points contained in one such hypercube were averaged to create a single point in the training data set. In some embodiments, only points from hypercubes containing one hundred or more original data points were kept and used.

In deciding how the neural network should be tested and how the output should be viewed, consideration was given to how the deterioration of high-bypass turbofan engines would appear. For these considered engines, EGT is considered to be an indicator of the engine's health. The EGT margin is defined as the amount that the EGT is below the allowable limit for a given stage in the flight. When an engine is new, its EGT margin is at its highest. Over time, it shrinks until the engine must be retired.

In some embodiments, because none of the five input variables used herein were time or health-dependent, it was inferred that the neural network would not be sensitive to changes in an engine's health. Thus, a residual EGT (i.e., the difference between the predicted and actual EGT) for a particular engine should change with time as the engine deteriorates or has maintenance performed on it. Based on this information, the network was tested for one engine at a time and residual EGT was recorded for each data point. Additionally, it was determined that an increase in residual EGT would be equivalent to a decrease in EGT margin. Therefore, the speed at which residual EGT changes for a given engine should indicate how quickly the health of the engine deteriorates as a whole.

Subsequent to collecting time-dependent residuals for a given engine, these residuals needed to be analyzed in order to pinpoint the differences between engines. The approach for such an analysis was determined by Applicants between several graphs of residuals vs. time.

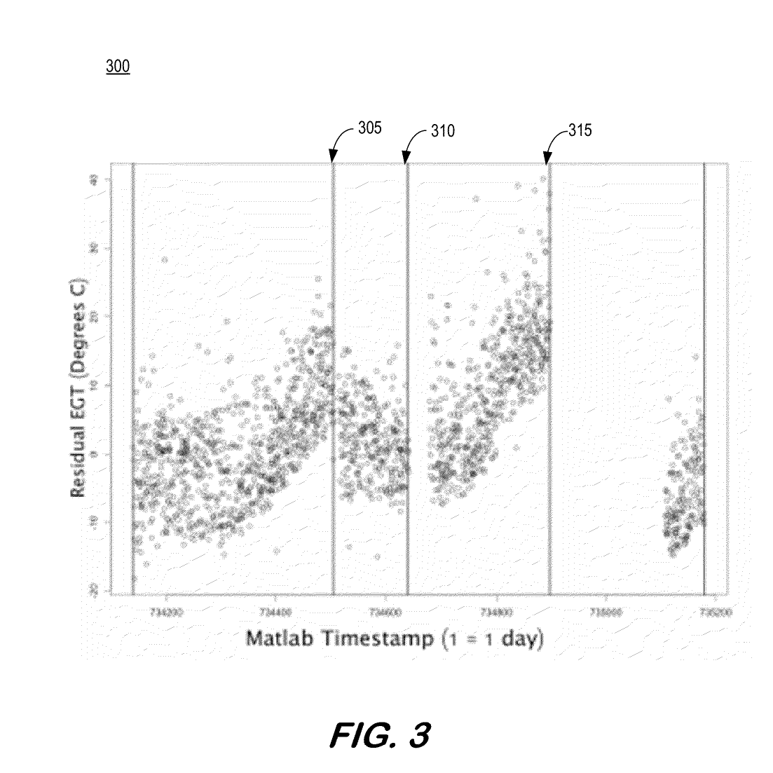

Referring more specifically to FIG. 3, graphical data 300 shows that residual EGT tends to increase with time, as expected, until there are sudden shifts in the graph. At these points or jumps (e.g., 305, 310, and 315), residual EGT decreases by a few degrees Celsius before continuing to follow the same upward trend as before. These jumps downward indicated maintenance had been performed on the engine.

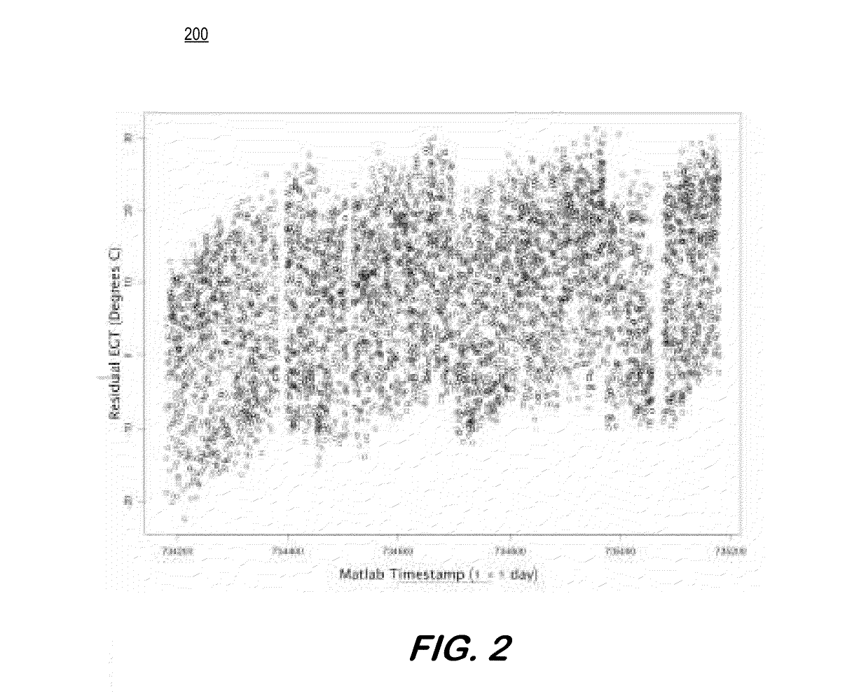

In the absence of maintenance data, two different strategies were used to devise a method of finding these jumps. First, groundings for an extended period of time, more than five days, were assumed to be maintenance events. In that each data point corresponds to one flight, all pairs of points separated by five days or more were found. This length of time allowed for planes to be grounded for weather or other non-maintenance reasons such as the temporary closure of an airport. Next, downward jumps in the data were detected using criteria similar to that used in visual identification. That is, times were identified when a local max was closely followed by a local min at both the top and bottom of the band of residual EGT, giving the appearance of a downward vertical shift, as best illustrated in FIG. 2.

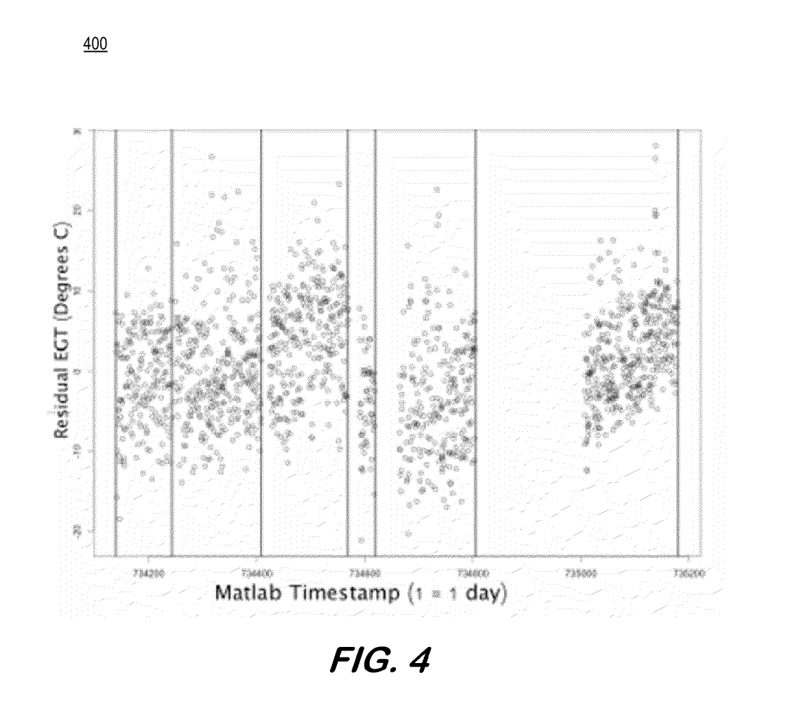

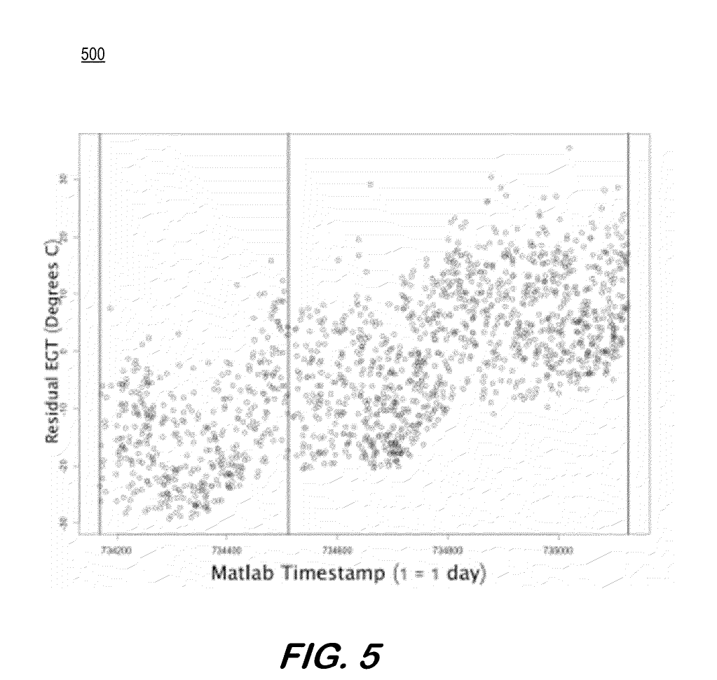

Referring more specifically to FIGS. 3-5, illustrated are several examples (e.g., graphs 400 and 500) of the algorithm's success in identifying maintenance-like events. Without ground truth for maintenance event timing, the success of the jump-finding algorithm was judged by evaluating how often it correctly identified maintenance events compared with identification with the naked eye. Testing this method on several different graphs of residuals vs. time, we found that this method correctly identified 80 to 90 percent of the vertical discrepancies that were perceived by the naked eye to probably indicate a maintenance event. In addition, very few false positive events were identified.

After the boundaries of the jumps were found, it remained to determine how quickly residuals changed between those boundaries. The first step in this endeavor was to cluster the data using the built-in k-means clustering algorithm (MacQueen, 1967). K-means clustering partitions a set of observations into k clusters such that the sum of the errors (distance between the cluster center and points contained in the cluster) is minimized. This was done by choosing k points, assigning each data point to the closest of those k points, and calculating the new average of each of the k sets of points. This was repeated until the centers of the clusters no longer move (MacQueen, 1967). There are many different methods that can be used to find an ideal number of clusters, k, although it has been noted that there is not necessarily a unique best value (Sugar & James, 2003) In light of this, the number of clusters by performing k-means on several different time-series of residual EGT were chosen, noting how many centers would effectively cut down the noise in the data, likely due to differences in variables for which were not accounted for, while still demonstrating the moving trend. For this data set, approximately one center per 150 data points was found to provide a good compromise.

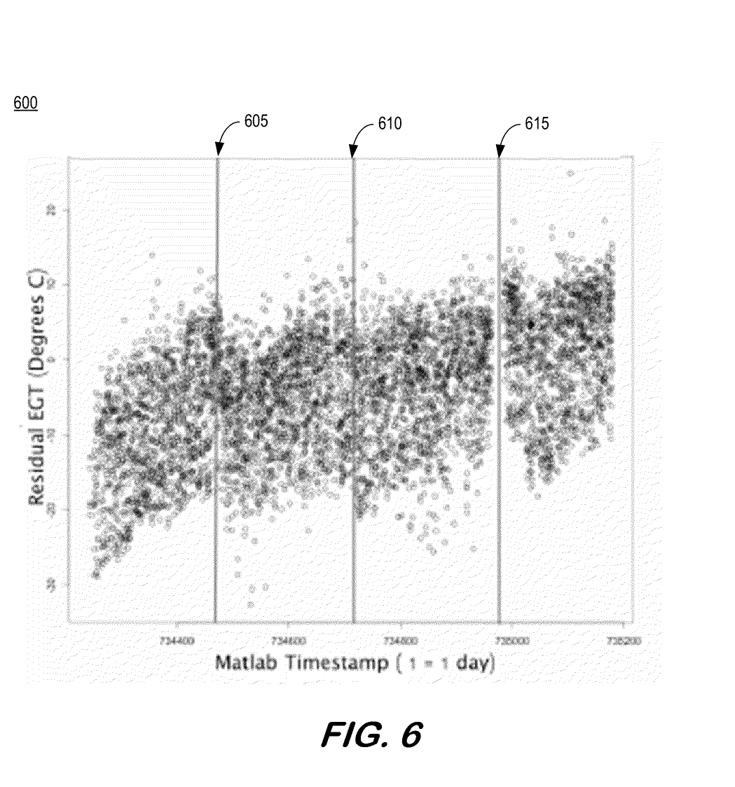

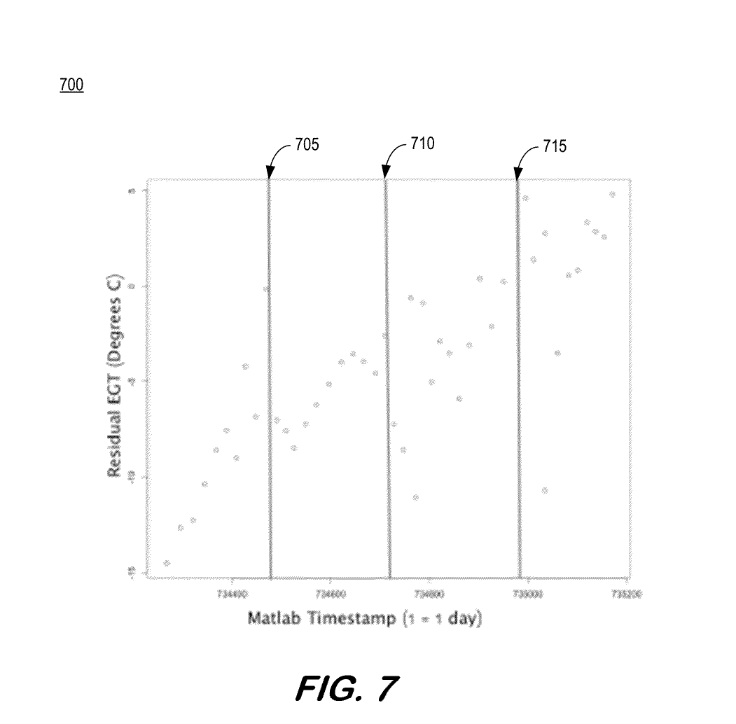

Referring more specifically to FIGS. 6 and 7, illustrated are examples of the effects of the k-means clustering algorithm, which contains a plot of the original residual EGT output for a single engine, alongside the points obtained by the clustering algorithm run over the output data set, respectively. In both plots, vertical lines mark maintenance. FIGS. 6 and 7 illustrate that the resulting set of clustered points (700) does indeed serve as a good approximation of the original data set (600) while making performing regressions simpler. Between each set of maintenances jumps (i.e., 605/610/615 and 705/710/715), the EGT changes in a predominantly linear fashion and the net trend is similar to those in the original data.

An exponential smoothing algorithm with a small smoothing coefficient was next used to smooth the data (Ostertagova & Ostertag, 2012). This technique was employed to bring potentially noisy data points just slightly closer to a perceived trend line, again to improve the accuracy of regression. Finally, three fits were made of the data: exponential (ln(residual) vs. time), quadratic (square root of residual vs. time) and linear. All of the appropriate equation shifts and coefficients were recorded along with the correlation coefficients. Later, this information was used to determine the best type of model for deterioration as a function of time.

Bearing in mind the ultimate goal of quantifying deterioration and engine usable life as they differ based on environmental factors and flight characteristics, the type of deterioration must first be characterized. When the groups of clustered points were analyzed, the average Pearson's r values for the three types of regressions were nearly identical over the entire set of engines, likely due to the small number of clustered points and fairly slow rate of change between maintenances. Based on this criterion, no single equation type was clearly superior. Previous work demonstrates that EGT margin deterioration rates stabilize after a period of fast initial loss and remain fairly constant until the engine needs to be removed (Ackert, 2011), it was determined that the general form of deterioration between maintenances would be

residual EGT=αt+β (1)

In Eq. (1), t is the number of days since the first flight in the recorded data set, and α and β are coefficients determined by a linear regression. It can be seen from this equation that the speed of engine deterioration is determined by α, indicating that this will be the quantity of interest. Further, β is understood to be the initial deterioration of the engine at time t=0. Going forward, α will be referred to as the deterioration coefficient.

When an increase in EGT margin through maintenance events is taken into account, Eq. (1) is not a complete description of the progression of residual EGT as a function of time. When several different types of maintenances are considered, numbered {1, . . . , k}, which can be performed throughout the engine's lifetime, the fully general expression for residual EGT (or, equivalently, decrease in EGT margin) is

residual EGT=αt+β−Σᵢ₌₁^{k}nᵢδᵢ (2)

In Eq. (2), δᵢ is the increase in EGT margin attributed to maintenance type i and nᵢ is the number of times that maintenance type i has been performed between the beginning of the engine's lifetime and time t.

Having determined the most likely function for EGT margin deterioration as a function of time, it remains to quantify how this depends on environmental factors and cycle frequency. It must be noted that the character of deterioration may be different and less linear towards the beginning or end of an engine's life. However, the data on initial installation dates is currently unavailable and the possible time-dependency will not be considered for the purposes of this disclosure. Accordingly, a strictly linear model of deterioration is considered.

In determining the appropriate equation for deterioration coefficient as a function of cycle frequency (f), the density of particles in the atmosphere near takeoff (PM10 in μg/m³, denoted p, taken from a database of experimental PM10 values), and effective passenger mass (denoted m and calculated based on the number of first/business/economy class passengers on a flight), observed mathematical relationships and one physical constraint were taken into account. The limit placed on the equation was that if f=0, α=0. That is, if an engine is never in flight, it will experience negligible or zero deterioration. As a consequence of this assumption and the observation that there was a very strong positive linear correlation between deterioration coefficient and cycle frequency, it is concluded that the general form of the equation for deterioration coefficient is

af,p,m=g(p,m)(Af) (3)

Where g (p, m) is an unknown function of p and m. Ultimately, we found that g(p, m) was well approximated by the general form

gp,m=(Bp+C)(Dm+F) (4)

Therefore, the complete equation for α will be

af,p,m=(Bp+C)(Dm+F)(Af) (5)

In Eq. (5), the units of α are degrees Celsius per day. This equation can be used to predict the lifetime of an engine in days or years assuming a constant cycle frequency. If the lifetime of an engine simply in the number of cycles is desired to be predicted, the quantity γ=α/f can be defined as the deterioration coefficient in units of degrees Celsius per cycle. Then, Eq. (5) can be equivalently written as

γp,m=A(Bp+C)(Dm+F) (6)

where B, C, D, and F are constants which can be determined for airlines operating in different climates.

It is noted that the relevant data points here are airlines, not engines. The average deterioration coefficient (α) and cycle frequency (f) were found for all of the engines with a common central hub operating under the same airline. Values of p and m were taken from the PM10 data at the most common hub city and seating configuration for each airline, respectively. In determining airplane load, passenger mass was the only consideration because it was assumed that the cargo bay would be filled equally between planes and that the differences in overall load would come from varying numbers of passengers on the plane. This choice was motivated by the fact that there is a good deal of variance in the distributions of deterioration coefficients for an airline.

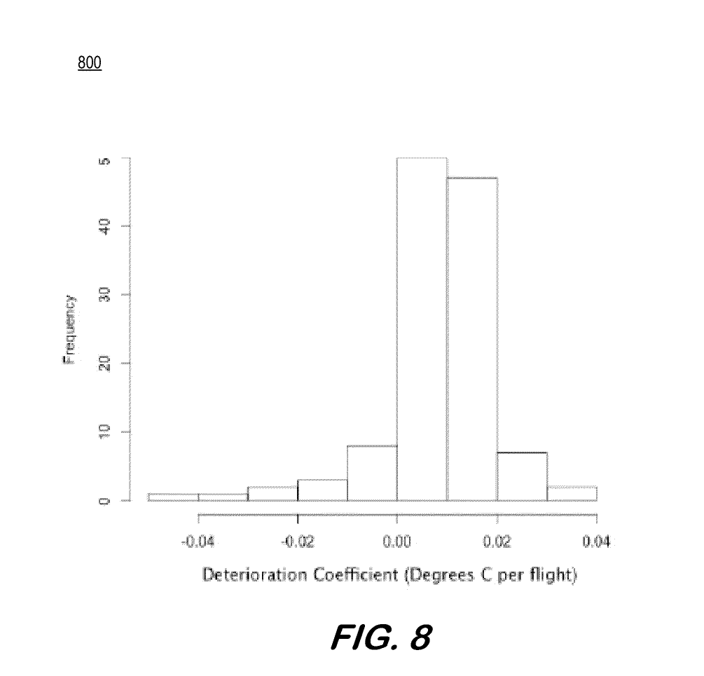

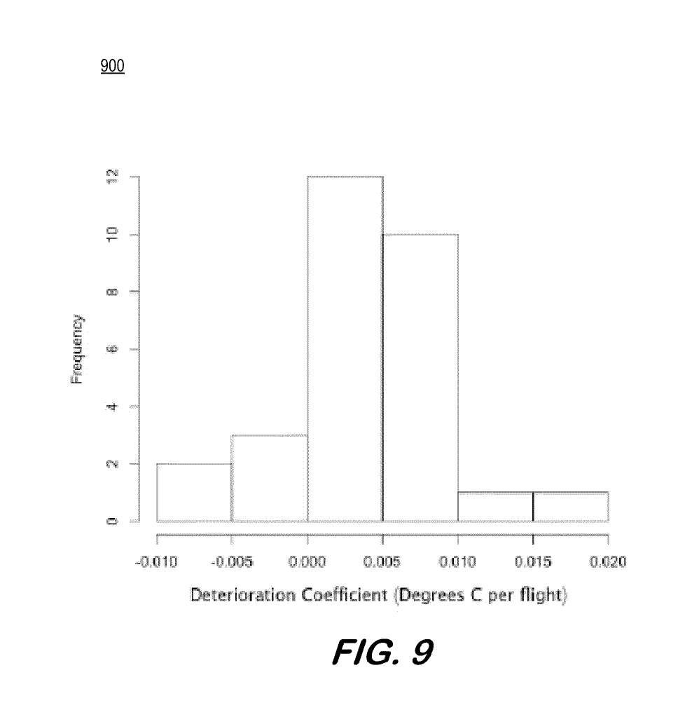

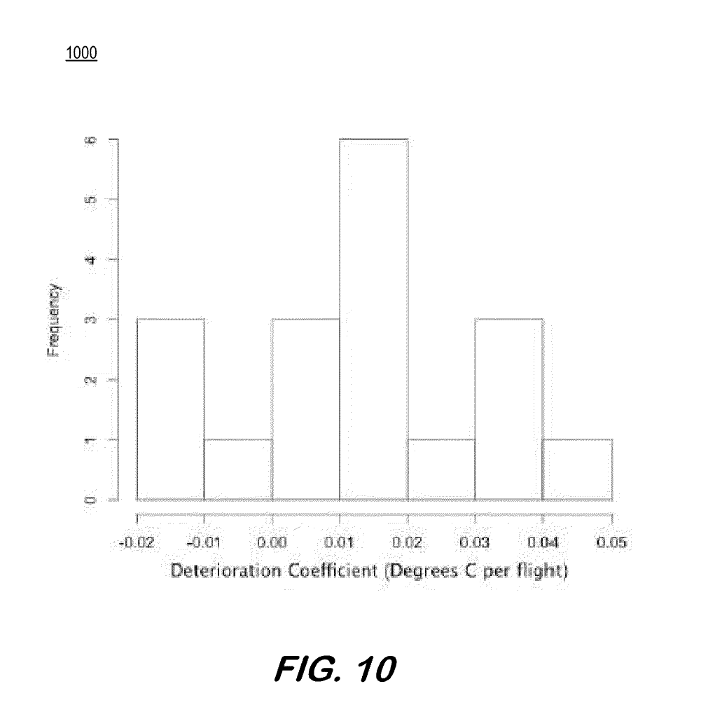

As best illustrated in FIGS. 8-10, the distributions of the deterioration coefficients have well defined peak values. Therefore, this information is the most meaningful as it applies to groups of engines with common characteristics. In this case, those belonging to a single airline.

Having derived an appropriate equation for deterioration coefficient, it remains to be shown how the unknown constants vary with the climate of the main hub of these airlines. To begin, the main hub city for each airline was designated as one of five climate types, Tropical/Equatorial, Dry (arid/semiarid), Mild temperate, Continental/Microthermal or Polar, based on the Köppen-Geiger climate classification system, the most frequently-used set of climate classification criteria (Kottek, Grieser, Beck, Rudolf and Rubel, 2006). The motivation for such a classification comes from the fact that several factors, including air composition, average precipitation, seasonal humidity variations, that may effect engine performance but for which in-flight data is not available, differ greatly between different locations around the globe. In the Köppen-Geiger classification system, these are accounted for and geographic locations are grouped according to the typical ranges of values exhibited for these characteristics. Grouping airlines in this way allows us to potentially reduce some of the error due to conditions we cannot quantitatively account for. Kottek et al. (2006) provide a detailed description of the criteria considered for these classifications.

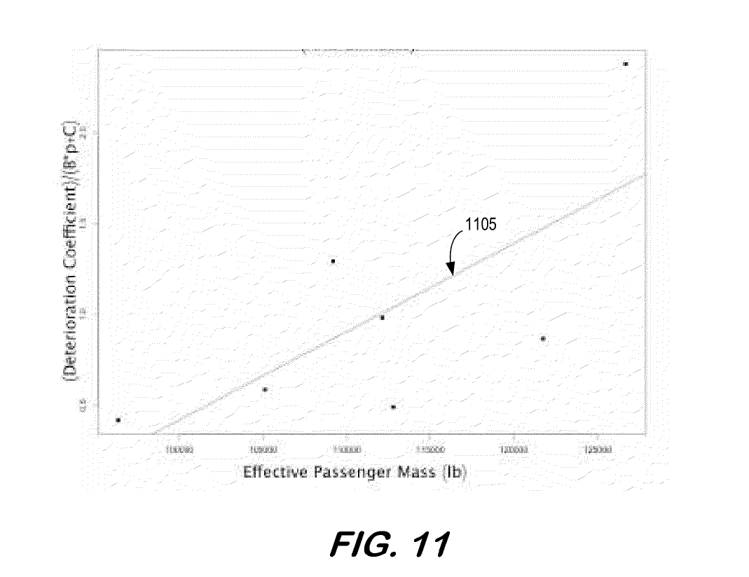

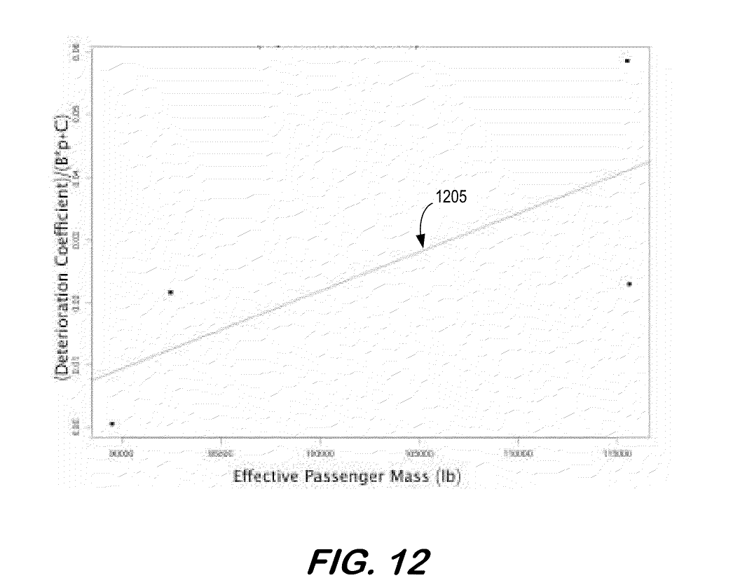

The coefficients for Eq. (6) were next determined for engines operating in both Arid/Semiarid and Equatorial climates. The lines of the equations derived for Arid and Equatorial climates are shown in FIGS. 11 and 12 at 1105 and 1205 respectively, graphed in the form

$$\frac{r ( p , m )}{Bp + C} = A ( Dm + F )$$

along with the points for airlines corresponding to those climates.

For Arid climates, it was found that the equation for γ would be

γ(p,m)=(1.31·10⁻⁵p+0.0033)(4.84·10⁻⁵m−4.44) (7)

And similarly, in Equatorial climates

γ(p,m)=(−5.81·10⁻⁷p+0.0012)(1.25·10⁻⁶m−0.10) (8)

Based on Eq. (7) and Eq. (8), it can be seen that the dependency of γ on the different input parameters varies based on climate. In arid climates, where flight conditions are generally harsher, it can be seen that

$$\begin{matrix}\frac{\partial γ}{\partial p} = ( 1.31 \cdot {10}^{- 5} ) ( 4.84 \cdot {10}^{- 5} m - 4.44 ) & ( 9 ) \\ \frac{\partial γ}{\partial m} = ( 1.31 \cdot {10}^{- 5} p + 0.0033 ) ( 4.84 \cdot {10}^{- 5} ) & ( 10 )\end{matrix}$$

With values for p on the order of 10² and m on the order of 10⁵, the values of the partial derivatives of γ with respect top and m, respectively, are on the order of 10⁻⁶ and 10⁻⁷.

On the other hand, in Equatorial climates

$$\begin{matrix}\frac{\partial γ}{\partial p} = ( - 5.81 \cdot {10}^{- 7} ) ( 1.25 \cdot {10}^{- 6} m - 0.10 ) & ( 11 ) \\ \frac{\partial γ}{\partial m} = ( - 5.81 \cdot {10}^{- 7} p + 0.0012 ) ( 1.25 \cdot {10}^{- 6} ) & ( 12 )\end{matrix}$$

Using the same estimates for p and m, it can be seen that the values of the partial derivatives of γ with respect top and m, respectively, are on the order of 10⁻⁸ and 10⁻⁹, almost negligible compared with those in Arid climates. So it can be seen that in less harsh climates, deterioration coefficient is much less sensitive to changes in flight conditions.

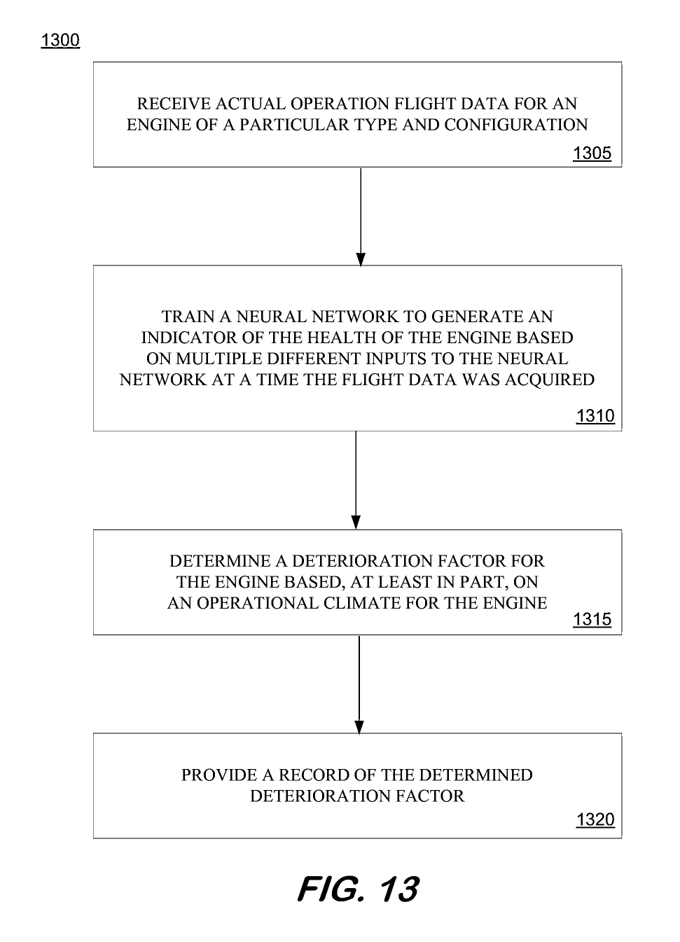

Referring to FIG. 13, a process related to providing a platform or framework for delivery of a predictive modeling service is disclosed. In some embodiments, the service may include a predictive modeling of high-bypass turbofan engine deterioration, in accordance with various aspects of the present disclosure. Process 1300 may be implemented by a system, application, or apparatus configured to execute the operations of the process. In some embodiments, various hardware elements of an apparatus, device or system executes program instructions to perform process 1300. In some embodiments, hard-wired circuitry may be used in place of, or in combination with, program instructions for implementation of processes according to some embodiments. Program instructions that can be executed by a system, device, or apparatus to implement process 1300 (and other processes or portions thereof disclosed herein) may be stored on or otherwise embodied as non-transitory, tangible media. Embodiments are therefore not limited to any specific combination of hardware and software.

Prior to operation 1305, applications, applications as a service, and web services executing on a device or a server-side computing device (e.g., an application server) may be developed and deployed to one or more backend systems. Conversely, one or more web applications may be developed and deployed for execution on a client-side device. Process 1300 may facilitate and support delivery of a service to the application that is not part of the application.

At operation 1305, flight data for an engine is received for use in predicting a deterioration of the engine and/or other engines of the same type and configuration. The sameness and specification of an engine of a particular type and configuration in some embodiments herein is a condition to delivering a deterioration prediction that is particularly accurate for a given context and application. In some aspect, the flight data is representative of actual operational flight data acquired based on real-life operations of the subject engine. The flight data may include various parameters and their corresponding values, including but not limited to, engine inputs, engine outputs, environmental data, timestamps, and other data points.

In some embodiments, at least portions of the flight data received at operation 1305 may be pre-processed or otherwise conditioned to be useful in process 1300. The extent of the pre-processing is not limited to any specific protocol or technique and may be varied to accommodate the prerequisites of process 1300 and/or an implementation thereof

At operation 1310, a neural network to generate an indicator of the health of the engine is trained. The neural network may be designed, developed, and implemented in accordance with the neural network(s) discussed hereinabove. In accordance with some embodiments herein, the engine's health indicator may be the EGT of the engine. The EGT may be determined by the neural network based on multiple, different factors. In some embodiments, the multiple, different factors may include, at least, a bleed ratio, an altitude, a Mach number, an ambient temperature, and a N1 value for the engine corresponding to and representative of the actual values for the engine at the time the flight data was acquired.

Operation 1315 includes determining a deterioration factor for the engine based on, at least, an operational climate for the engine. In some aspects, as discussed hereinabove, in addition to the deterioration factor herein considering the time of the engine's stage of operation, the climate in which the engine operates is also considered and accounted for. The operational climate may greatly impact the health of the engine. Accordingly, operation 1315 may determine the deterioration factor for the engine based on the engine operating in one of a plurality of different possible climates.

Operation 1320 may include the generation and output of a record of the determined deterioration factor. The determined deterioration factor may be stored in one or more different formats and persisted in a number of different types of media, including local, remote, and cloud-based storage systems, facilities, and devices. The persisted or stored record(s) of the determined deterioration factor may be further processed, either alone or in combination with other processes, to provide insight into the health of an entity's (e.g., an airline operator/owner) jet engines. In some aspects, the record(s) of the determined deterioration factor may be used or consumed by a business analytics application or service.

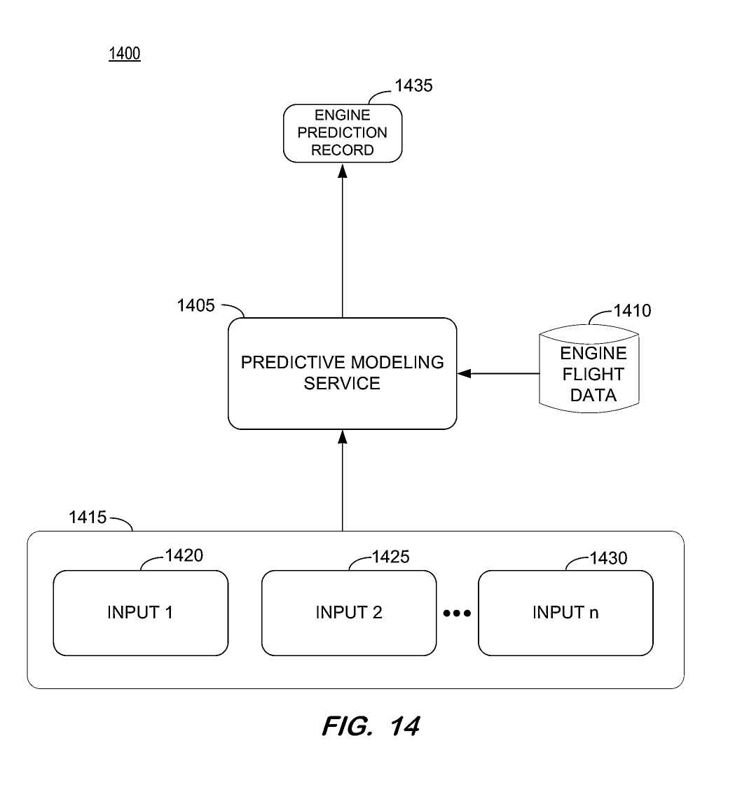

FIG. 14 depicts a logical platform or framework for a predictive modeling service, in accordance with some embodiments herein. Predictive modeling service 1405 may be designed and developed in accordance with the neural network based predictive processes disclosed herein. As such, predictive modeling service 1405 may provide accurate, reliable, efficient, and applicable deterioration predictions for a particular engine based on actual flight data 1410. In some aspects, flight data 1410 may be received from a third-party service provider or data aggregator.

Predictive modeling service 1405 may also operate to receive multiple, different inputs 1415. The different multiple inputs may include inputs 1420, 1425, and 1430, where some embodiments includes the five inputs used in the example(s) herein. It is noted that the data inputs 1415 are not limited to the specific five inputs specifically used in the example(s) of the present disclosure or any specific number. That is, the inputs may include one or more inputs where n may be limited (if at all) to a processing practicality, available useful data, other considerations and not function of the predictive modeling process.

In some embodiments, predictive modeling service 1405 may use the inputs 1415 and generate a deterioration factor that is output in engine prediction record 1435. Engine prediction record 1435 may be used to gain insight into the health of an entity's engines, either directly from the engine prediction record 1435 and/or based on further processing and presentation of the engine prediction record 1435.

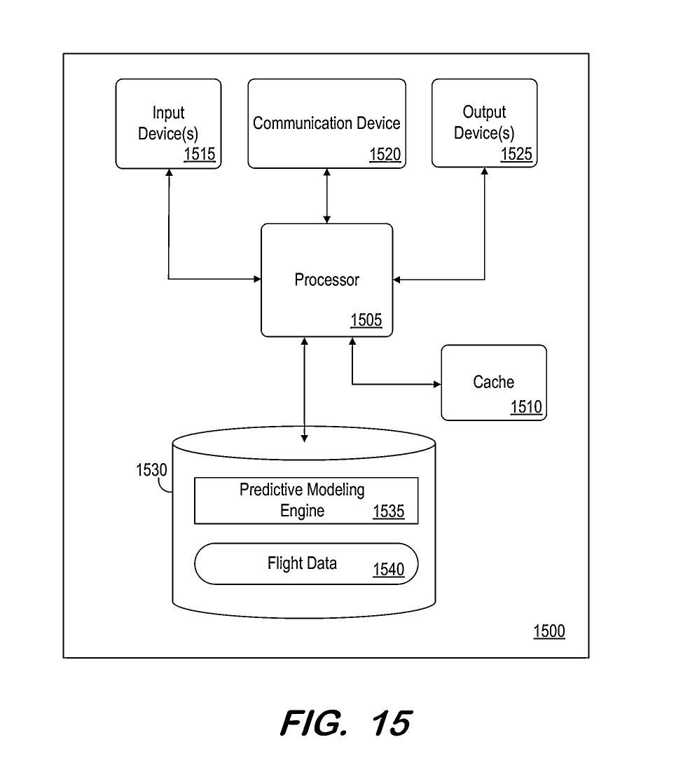

FIG. 15 is a block diagram overview of a system or apparatus 1500 according to some embodiments. System 1400 may be, for example, associated with any of the devices described herein, including for example a platform of FIG. 14 and aspects thereof, in accordance with processes disclosed herein. System 1500 comprises a processor 1505, such as one or more commercially available Central Processing Units (CPUs) in the form of one-chip microprocessors or a multi-core processor, coupled to a communication device 1520 configured to communicate via a communication network (not shown in FIG. 15) to another device or system. In the instance system 1500 comprises a device or system (e.g., supporting a predictive modeling of high-bypass turbofan engine deterioration platform), communication device 1520 may provide a mechanism for system 1500 to interface with a business organization or application, device, system, or service. System 1500 may also include a cache 1510, such as RAM memory modules. The system may further include an input device 1515 (e.g., a touchscreen, mouse and/or keyboard to enter content) and an output device 1525 (e.g., a touchscreen, a computer monitor to display, a LCD display).

Processor 1505 communicates with a storage device 1530. Storage device 1530 may comprise any appropriate information storage device, including combinations of magnetic storage devices (e.g., a hard disk drive), optical storage devices, solid state drives, and/or semiconductor memory devices. In some embodiments, storage device 1530 may comprise a database system, including in some configurations an in-memory database, a relational database, and other systems.

Storage device 1530 may store program code or instructions 1535 that may provide processor executable instructions for managing a predictive modeling predictive modeling of high-bypass turbofan engine deterioration platform, in accordance with processes herein. Processor 1505 may perform the instructions of the program instructions 1535 to thereby operate in accordance with any of the embodiments described herein. Program instructions 1535 may be stored in a compressed, uncompiled and/or encrypted format. Program instructions 1535 may furthermore include other program elements, such as an operating system, a database management system, and/or device drivers used by the processor 1505 to interface with, for example, peripheral devices (not shown in FIG. 15). Storage device 1530 may also include data 1540 such as engine flight data disclosed in some embodiments herein. Data 1540 may be used by system 1500, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

It is anticipated by this disclosure that additional parameters may be considered in the development of the model, such as runway length, fuel efficiency, or other indicators of how the plane is flown differently between airlines.

Accordingly, disclosed is a tool that may be used to help manufacturers and users of high-bypass turbofan engines to make estimates on the relative lifetimes of engines under different conditions with reasonable accuracy. Using the specific value of α or, equivalently, γ for a given airline, along with a pre-specified maintenance plan and initial EGT margin, Eq. (2) can be used to predict either the number of days or cycles that an engine will last on the wing of a plane. Both airlines and engine manufacturers can use this information to determine how often an engine needs to be maintained for it to reach a desired number of cycles or years of use.

Once lifetime estimates and maintenance patterns are determined for a specific engine, this information can be used in financial considerations for producers and consumers. Companies that produce or maintain engines, knowing what the maintenance frequency will likely be, can use this information to determine how much maintenance events should cost to appropriately offset the price of producing the engine. Airlines can use this model and the resulting recommended maintenance patterns in a similar way. Knowing how much an airline will need to spend on an engine (or a set of engines in a fleet) during its usable life will allow ticket prices to be adjusted accordingly.

The disclosed model has the potential to help save both time and resources. In addition, the disclosed model allows for fleet-level modeling of maintenance requirements. This could be used, e.g., for more accurately predicting shop costs.

The embodiments described herein are solely for the purpose of illustration. Those in the art will recognize other embodiments which may be practiced with modifications and alterations.

What is claimed is:

1. A method, the method comprising:
receiving actual operation flight data for an engine of a particular type and configuration;
training a neural network to generate an indicator of the health of the engine based on multiple different inputs to the neural network at a time the flight data was acquired;
determining a deterioration factor for the engine, based at least in part, on an operational climate for the engine; and
providing a record of the determined deterioration factor.

2. The method of claim 1, wherein the engine comprises a high-bypass turbofan engine.

3. The method of claim 1, wherein the health of the engine is indicated by an exhaust gas temperature parameter for the engine.

4. The method of claim 1, wherein the multiple different inputs to the neural network include at least a bleed ratio, a Mach number, a percentage of maximum fan speed of the engine, ambient temperature, and altitude.

5. The method of claim 1, wherein the climate is determined to be at least one of the following different climates: tropical/equatorial, dry, mild temperate, continental/microthermal, and polar.

6. The method of claim 1, wherein the deterioration factor is determined on a basis of an airline operator.

7. A non-transitory medium storing processor-executable program instructions, the medium comprising program instructions executable by a computer to:
receive actual operation flight data for an engine of a particular type and configuration;
train a neural network to generate an indicator of the health of the engine based on multiple different inputs to the neural network at a time the flight data was acquired;
determine a deterioration factor for the engine based, at least in part, on an operational climate for the engine; and
provide a record of the determined deterioration factor.

8. The medium of claim 7, wherein the engine comprises a high-bypass turbofan engine.

9. The medium of claim 7, wherein the health of the engine is indicated by an exhaust gas temperature parameter for the engine.

10. The medium of claim 7, wherein the multiple different inputs to the neural network include at least a bleed ratio, a Mach number, a percentage of maximum fan speed of the engine, ambient temperature, and altitude.

11. The medium of claim 7, wherein the climate is determined to be at least one of the following different climates: tropical/equatorial, dry, mild temperate, continental/microthermal, and polar.

12. The medium of claim 7, wherein the deterioration factor is determined on a basis of an airline operator.

13. A system comprising:
a computing device comprising:
a memory storing processor-executable program instructions; and
a processor to execute the processor-executable program instructions to cause the computing device to:
receive actual operational flight data for an engine of a particular type and configuration;
train a neural network to generate an indicator of the health of the engine based on multiple different inputs to the neural network at a time the flight data was acquired;
determine a deterioration factor for the engine, based at least in part, on an operational climate for the engine; and
provide a record of the determined deterioration factor.

14. The system of claim 13, wherein the engine comprises a high-bypass turbofan engine.

15. The system of claim 13, wherein the health of the engine is indicated by an exhaust gas temperature parameter for the engine.

16. The system of claim 13, wherein the multiple different inputs to the neural network include at least a bleed ratio, a Mach number, a percentage of maximum fan speed of the engine, ambient temperature, and altitude.

17. The system of claim 13, wherein the climate is determined to be at least one of the following different climates: tropical/equatorial, dry, mild temperate, continental/microthermal, and polar.

18. The system of claim 13, wherein the deterioration factor is determined on a basis of an airline operator.
